(19) United States
(12) Patent Application Publication
(10) Pub. No.: US 2023/0196805 A1
(43) Pub. Date: Jun. 22, 2023

(54) CHARACTER DETECTION METHOD AND APPARATUS , MODEL TRAINING METHOD AND APPARATUS, DEVICE AND STORAGE MEDIUM

(71) Applicant: BEIJING BAIDU NETCOM SCIENCE TECHNOLOGY CO., LTD., Beijing (CN)

(72) Inventors: Ju HUANG, Beijing (CN); Xiaoqiang ZHANG, Beijing (CN); Xiameng QIN, Beijing (CN); Chengquan ZHANG, Beijing (CN); Kun YAO, Beijing (CN)

(73) Assignee: BEIJING BAIDU NETCOM SCIENCE TECHNOLOGY CO., LTD., Beijing (CN)

(21) Appl. No.: 18/168,089

(22) Filed: Feb. 13, 2023

(30) Foreign Application Priority Data
Apr. 18, 2022 (CN) 202210404529.4

(51) Int. Cl. G06V 30/10; G06T 7/11; G06V 10/25; G06V 10/44

(52) U.S. Cl. CPC G06V 30/10; G06T 7/11; G06V 10/25; G06V 10/44

(57) ABSTRACT

The present disclosure provides a character detection method and apparatus, a model training method and apparatus, a device and a storage medium. The specific implementation is: acquiring a training sample, where the training sample includes a sample image and a marked image, and the marked image is an image obtained by marking a text instance in the sample image; inputting the sample image into a character detection model, to obtain segmented images and image types of the segmented images output by the character detection model, where the image type indicates that the segmented image includes a text instance, or the segmented image does not include a text instance; and adjusting a parameter of the character detection model according to the segmented images, the image types of the segmented images and the marked image.

### CROSS-REFERENCE TO RELATED APPLICATIONS

The present application claims priority to Chinese patent application No. 202210404529.4, filed with the China National Intellectual Property Administration on Apr. 18, 2022, entitled “Character Detection Method and Apparatus, Model Training Method and Apparatus, Device and Storage Medium”, which is hereby incorporated by reference in its entirety.

### TECHNICAL FIELD

The present disclosure relates to the technical field of artificial intelligence, and specifically, to the technical field of deep learning, image processing and computer vision, which can be applied in scenarios such as optical character recognition (OCR), and in particular, to a character detection method and apparatus, a model training method and apparatus, a device and a storage medium.

### BACKGROUND

Character detection refers to a process of detecting text areas in pictures containing characters. Specifically, a task of the character detection is to output a bounding box of each target text in an image, regardless of specific semantic content of the target text.

Character detection is an important part of applications such as character recognition, product search, etc. The accuracy of character detection will affect the effect of subsequent character recognition. Therefore, it is necessary to provide a high-accuracy character detection solution to improve the ability for character detection, and effectively enhance the accuracy and robustness of services such as ID card identification, document identification, bill identification, etc.

### SUMMARY

The present disclosure provides a character detection method and apparatus, and a model training method and apparatus, a device and a storage medium.

According to a first aspect of the present disclosure, a character detection method is provided, including:

acquiring a first to-be-detected image;

inputting the first image into a character detection model, to obtain segmented images and image types of the segmented images output by the character detection model, where the image type indicates that the segmented image includes a text instance, or the segmented image does not include a text instance; and

determining a target area in the first image according to the segmented images and the image types, where the target area includes a text instance.

According to a second aspect of the present disclosure, a model training method is provided, including:

acquiring a training sample, where the training sample includes a sample image and a marked image, where the marked image is an image obtained by marking a text instance in the sample image;

inputting the sample image into a character detection model, to obtain segmented images and image types of the segmented images output by the character detection model, where the image type indicates that the segmented image includes the text instance, or the segmented image does not include the text instance; and

adjusting a parameter of the character detection model according to the segmented images, the image types of the segmented images and the marked image.

According to a third aspect of the present disclosure, an electronic device is provided, including:

at least one processor; and

a memory communicatively connected to the at least one processor; where

the memory stores an instruction executable by the at least one processor, and the instruction is executed by the at least one processor to cause the at least one processor to perform the method according to any one of the first aspect or the second aspect.

According to a fourth aspect of the present disclosure, a non-transitory computer-readable storage medium storing a computer instruction is provided, where the computer instruction is used to cause a computer to perform the method according to any one of the first aspect or the second aspect.

According to the techniques of the present disclosure, a training sample is first acquired, where the training sample includes a sample image and a marked image, and the marked image is an image obtained by marking a text instance in the sample image; the sample image is then input into a character detection model, to obtain a plurality of segmented images and image types of the segmented images output by the character detection model, where the image type indicates that the segmented image includes the text instance, or the segmented image does not include the text instance; and a parameter of the character detection model is adjusted according to the plurality of segmented images, the image types of the segmented images and the marked image. Since the marked image is obtained by marking the text instance in the sample image, after the text instance in the sample image is detected by the character detection model to obtain the segmented images and image types, the parameter of the character detection model can be adjusted based on the segmented images, image types and the marked image.

It should be understood that the content described in this section is not intended to identify key or important features of the embodiments of the present disclosure, nor is it intended to limit the scope of the present disclosure. Other features of the present disclosure will be readily understood from the following description.

### BRIEF DESCRIPTION OF DRAWINGS

The drawings are used for a better understanding of the present solution, and do not constitute a limitation of the present disclosure.

FIG. 1 is a schematic diagram of an application scenario provided by an embodiment of the present disclosure.

FIG. 2 is a schematic flowchart of a model training method provided by an embodiment of the present disclosure.

FIG. 3 is a schematic diagram of processing of a character detection model provided by an embodiment of the present disclosure.

FIG. 4 is a schematic flowchart of processing on a sample image by a character detection model provided by an embodiment of the present disclosure.

FIG. 5 is a schematic diagram of processing of a decoder module provided by an embodiment of the present disclosure.

FIG. 6 is a schematic diagram 1 of determining an area corresponding to a segmented image provided by an embodiment of the present disclosure.

FIG. 7 is a schematic diagram 2 of determining an area corresponding to a segmented image provided by an embodiment of the present disclosure.

FIG. 8 is a schematic flowchart of a character detection method provided by an embodiment of the present disclosure.

FIG. 9 is a schematic diagram of a character detection process provided by an embodiment of the present disclosure.

FIG. 10 is a schematic structural diagram of a character detection apparatus provided by an embodiment of the present disclosure.

FIG. 11 is a schematic structural diagram of a model training apparatus provided by an embodiment of the present disclosure.

FIG. 12 is a block diagram of an electronic device provided by an embodiment of the present disclosure.

### DESCRIPTION OF EMBODIMENTS

Exemplary embodiments of the present disclosure are described below with reference to the accompanying drawings, including various details of the embodiments of the present disclosure to facilitate understanding, which should be regarded as merely exemplary. Therefore, those skilled in the art should realize that various changes and modifications can be made to the embodiments described herein without departing from the scope and spirit of the present disclosure. Similarly, for clarity and conciseness, the description of well-known functions and structures is omitted in the following description.

Character detection refers to the process of detecting text areas in an image containing characters. Through character detection, a bounding box of a target text in the image can be output, but the specific semantic content of the target text is not concerned. Character detection is an important part of applications such as character recognition, product search, image and video understanding, automatic driving, etc., and the accuracy of detection directly affects the effect of subsequent recognition tasks.

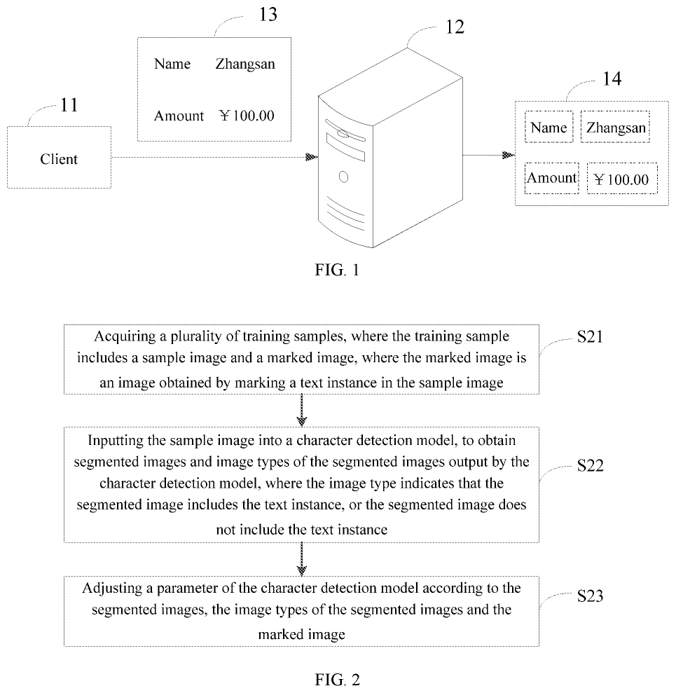

For example, the application scenario of the present disclosure can be described with reference to FIG. 1. FIG. 1 is a schematic diagram of an application scenario provided by an embodiment of the present disclosure. As shown in FIG. 1, it includes a client 11 and a server 12, and the client 11 and the server 12 are connected wirelessly or via a wire.

The client 11 sends a to-be-detected image 13 to the server 12, and the to-be-detected image 13 includes characters. After receiving the to-be-detected image 13, the server 12 can perform character detection on the to-be-detected image 13 to obtain a corresponding image detection result. For example, in FIG. 1, after the server 12 performs character detection on the to-be-detected image 13, a detected image 14 can be obtained, and in the detected image 14, characters on the to-be-detected image 13 are marked with rectangular boxes, and areas in the rectangular boxes are areas where the detected target texts are located.

In related arts, character detection is mainly based on methods of regression or segmentation. In the method based on regression, first a detection model is trained, and when the detection model is being trained, a training sample includes a sample image and marked information, and the marked information is a rectangular box for marking characters on the sample image. After the detection model is trained according to training samples, the detection model has the ability to detect the characters on the image, and can recognize a text area in the image. When the model is trained in the regression-based method, since only rectangular boxes are marked on the sample images, so this character detection method has a good effect on characters in regular shapes, but it has a poor effect on characters in irregular shapes, such as curved characters, so it tends to detect areas that do not belong to text areas as text areas, and to detect areas belong to text areas as non-text areas.

The method based on segmentation is mainly to classify an image at pixel level, which divides pixels into text area type and non-text area type, and then obtains the character detection result, i.e. text area, according to the division result. This character detection method can be used to detect characters in irregular shapes since it processes images at pixel level. However, this method needs to integrate the detection result at pixel level into corresponding character areas through a binarization operation in the subsequent processing, and for two text instances that are relatively close, this solution tends to divide them into the same text instance. Taking a photo in an ID card as an example, the photo in the ID card includes text “Name Zhangsan”, where “Name” is a text instance, and “Zhangsan” is another text instance. When these two text instances are close, the method based on segmentation tends to divide them as one text instance “Name Zhangsan”. Therefore, the method based on segmentation has a problem of low accuracy in character detection.

Based on this, the present disclosure provides a character detection method and apparatus, and a model training method and apparatus, a device and a storage medium, to address the above technical problems. In the following, the solution of the present disclosure will be described with reference to the drawings.

FIG. 2 is a schematic flowchart of a model training method provided by an embodiment of the present disclosure. As shown in FIG. 2, the method may include:
S21, acquiring a training sample, where the training sample includes a sample image and a marked image, where the marked image is an image obtained by marking a text instance in the sample image.

The sample image is an image used for model training, and the sample image includes characters, and the character detection model is used to detect the characters on the sample image. For any sample image, the corresponding marked image is an image obtained by marking a text instance on the sample image. The text instance represents an independent text entry type, and one text instance may include one or more characters.

The text instance will be described with reference to an example. By scanning a user's job application resume, a corresponding resume image is obtained, where the resume image includes name information of the user-“Name Zhangsan”. For this resume image, “Name” is one text instance on the resume image, and “Zhangsan” is another text instance on the resume image, and “Name” and “Zhangsan” are different text instances.

After acquiring the sample image, the sample image can be marked in the unit of text instance according to characters on the sample image, and manners for marking may include, for example, in the form of rectangular box, in the form of four-corner points, etc. An example is taken where the sample image includes two text instances, “Name” and “Zhangsan”, and the manner of marking is in the form of rectangular box, the text instance “Name” in the sample image can be marked through a first rectangular box, and the text instance “Zhangsan” in the sample image can be marked through a second rectangular box, so as to obtain the marked image corresponding to the sample image.

S22, inputting the sample image into a character detection model, to obtain segmented images and image types of the segmented images output by the character detection model, where the image type indicates that the segmented image includes the text instance, or the segmented image does not include the text instance.

After multiple groups of training samples are acquired, for any group of training sample, the sample image in the training sample can be input into the character detection model, and the sample image can be processed through the character detection model, to obtain a plurality of corresponding segmented images and image types of the respective segmented images.

In the embodiment of the present disclosure, the plurality of segmented images corresponding to the same sample image have the same size, and pixel values of pixels in different segmented images are different. For any segmented image, the image type of the segmented image indicates that the segmented image includes the text instance, or the segmented image does not include the text instance.

S23, adjusting a parameter of the character detection model according to the segmented images, the image types of the segmented images and the marked image.

After the plurality of segmented images and the image types of the segmented images are acquired, the text instance detected by the character detection model can be determined according to the plurality of segmented images and the image types of the segmented images. Then, a parameter of the character detection model is adjusted with reference to the text instance(s) marked in the marked image.

For any group of training samples, the character detection model can be trained through the above solution, and until a training termination condition is satisfied, the training process is terminated, and the trained character detection model is obtained. The training termination condition may include that, for example, a training times reaches a set maximum times, and for another example, a difference between the text instance detected by the character detection model and the text instance marked in the marked image is smaller than or equal to a preset difference value, etc.

According to the model training method provided by the embodiment of the present disclosure, a training sample is first acquired, where the training sample includes a sample image and a marked image, and the marked image is an image obtained by marking a text instance in the sample image; the sample image is then input into a character detection model, to obtain segmented images and image types of the segmented images output by the character detection model, where the image type indicates that the segmented image includes the text instance, or the segmented image does not include the text instance; and a parameter of the character detection model is adjusted according to the plurality of segmented images, the image types of the segmented images and the marked image. Since the marked image is obtained by marking the text instance in the sample image, after the text instance in the sample image is detected by the character detection model to obtain the segmented images and image types, the parameter of the character detection model can be adjusted based on the segmented images, image types and marked images, so that the character detection model has the ability to detect the text instance in the image after the training is completed, and characters in the image can be detected in the unit of text instance to obtain a detection result, and the accuracy of the character detection is high.

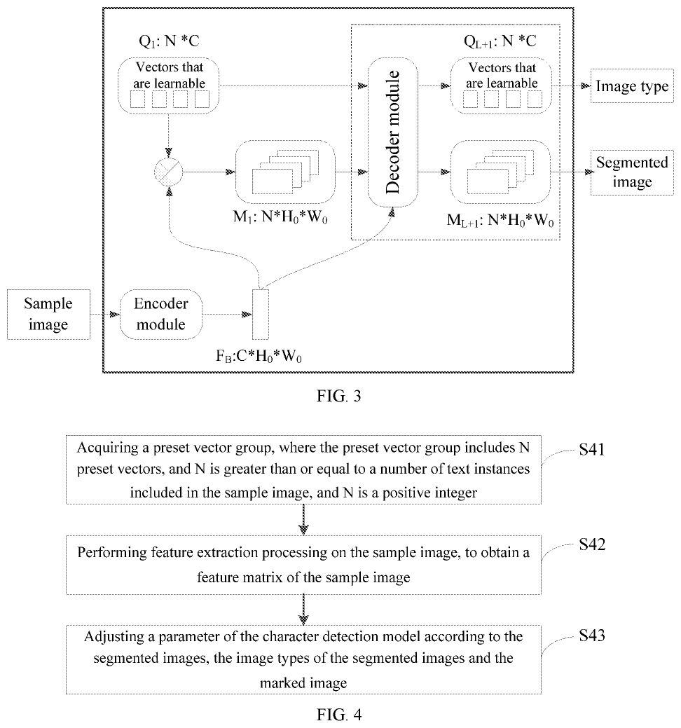

In order to enable readers to have a deeper understanding of the implementation principle of the present disclosure, the embodiment shown in FIG. 2 will be further refined with reference to the following FIG. 3-FIG. 6.

FIG. 3 is a schematic diagram of processing of a character detection model provided by an embodiment of the present disclosure. As shown in FIG. 3, the character detection model includes a preset vector group, an encoder module and a decoder module. After the sample image is input into the character detection model, feature extraction processing is first performed on the sample image through the encoder module, to obtain a feature matrix of the sample image, that is, the matrix F_{B} in FIG. 3.

The encoder module in the embodiment of the present disclosure can be any feature extraction network, for example, it can be a feature extraction network based on a convolutional neural network (CNN), a feature extraction network based on a deep self-attention transformer feature extraction network, or a network structure based on a mixture of CNN and Transformer.

On the basis of the structure of the character detection model illustrated in FIG. 3, the processing process on the sample image by the character detection model in S22 in the embodiment of FIG. 2 will be described below with reference to FIG. 4.

FIG. 4 is a schematic flowchart of processing on a sample image by a character detection model provided by an embodiment of the present disclosure. As shown in FIG. 4, including: S41, acquiring a preset vector group, where the preset vector group includes N preset vectors, and N is greater than or equal to a number of text instances included in the sample image, and N is a positive integer.

It needs to be note that, N is a parameter pre-defined in the character detection model, and N decides a maximum number of text instances that the character detection model can detect, and hence, N needs to be greater than or equal to the number of text instances included in the sample image. For example, the number of text instances included in a certain sample image is 100, and then N needs to take a value greater than or equal to 100, such as 150, 200, etc. Since the training process of the character detection model may require multiple sample images to be trained together, the value of N needs to be greater than or equal to the number of text instances included in any sample image.

In the example of FIG. 3, the preset vector group Q1 is an N*C matrix, and the preset vector group Q1 includes N preset vectors, and each preset vector includes C elements, where C is the number of channels. The preset vectors in the preset vector group Q1 are a group of vectors that are learnable. Initially, values of each element in the preset vector can be initialized, that is, original values of each preset vector can be set arbitrarily, for example, all values of the elements in each preset vector can be set to 0, 1, etc. In the process of subsequent model training, the preset vector will keep learning, so as to update the values of its own elements.

S42, performing feature extraction processing on the sample image, to obtain a feature matrix of the sample image.

Feature extraction on the sample image is implemented by the encoder module in the character detection model. By processing the sample image with the encoder module, the feature matrix F_{B} can be obtained. The feature matrix F_{B} is a feature matrix of C*H₀*W₀, and C, H₀ and W₀ are positive integers greater than or equal to 1. C represents the number of channels, and the value of C is related to the structure of the encoder module. The sizes of H₀ and W₀ are related to the size of the sample image. An example is taken where the size of the sample image is H₁*W₁, where H₁ represents the number of pixels included in each column of the sample image and W₁ represents the number of pixels included in each row of the sample image, then H₁=kH₀, W₁=kW₀, and k is a positive integer. The value of k is decided by the encoder module, and in some embodiments, k is greater than or equal to 1, for example, k may be 2, 4, 8, etc. By processing the sample image with the encoder module, the high-resolution features of the sample image can be extracted, thus improving the feature expression ability of the model and further improving the detection accuracy of the model.

S43, adjusting a parameter of the character detection model according to the segmented images, the image types of the segmented images and the marked image.

After the preset vector group and the feature matrix of the sample image are acquired, N segmented images and image types of the N segmented images can be obtained according to the preset vector group and the feature matrix.

As shown in FIG. 3, first, convolution processing is performed on the preset vector group Q₁ and the feature matrix F_{B} of the sample image, to obtain a first convolution matrix M₁, where M₁ is a matrix of N*H₀*W₀. Then, the preset vector group, the first convolution matrix and the feature matrix of the sample image are input into the decoder module, and the preset vector group, the first convolution matrix and the feature matrix of the sample image are processed through the decoder module, to obtain N segmented images and image types.

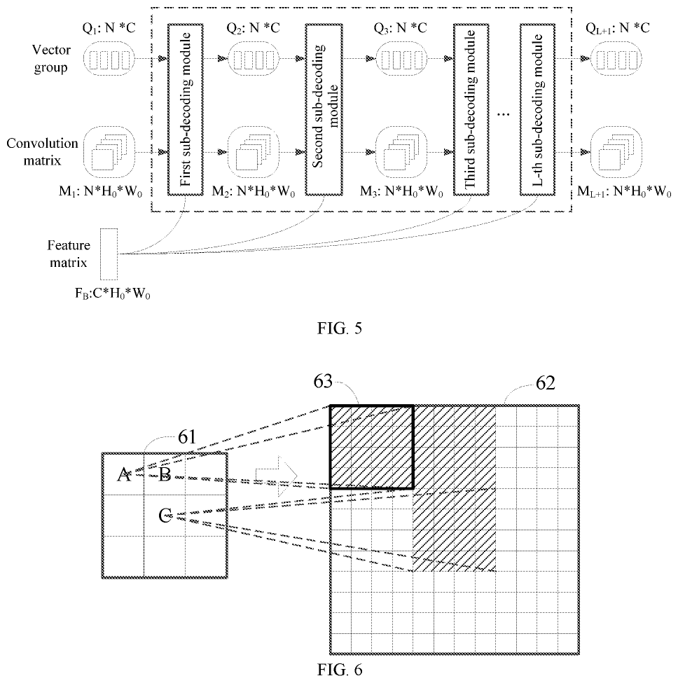

FIG. 5 is a schematic diagram of processing of a decoder module provided by an embodiment of the present disclosure. As shown in FIG. 5, input of the decoder module is the first convolution matrix, the preset vector group and the feature matrix of the sample image.

The decoder module includes L sub-decoding modules, which are called the first sub-decoding module, the second sub-decoding module, . . . , and the L-th sub-decoding module from left to right in FIG. 5.

After the first convolution matrix, the preset vector group and the feature matrix of the sample image are input into the decoder module, a first operation is performed, including: processing an i-th vector group, an i-th convolution matrix and the feature matrix of the sample image according to an i-th sub-decoding module, to obtain an (i+1)-th vector group and an (i+1)-th convolution matrix, and updating i to i+1. The first vector group is the preset vector group, and i is initially 1, and i is a positive integer.

When i is smaller than L, the first operation is repeatedly performed, until an (L+1)-th vector group and an (L+1)-th convolution matrix are obtained when i is equal to L.

For example, in FIG. 5, after the first convolution matrix M₁, the preset vector group Q₁ and the feature matrix F_{B} of the sample image are input into the decoder module, firstly, the preset vector group Q₁, the first convolution matrix M₁ and the feature matrix F_{B} are processed by the first sub-decoding module, to obtain a second vector group Q₂ and a second convolution matrix M₂, and updating of the preset vector Q₁ and the first convolution matrix M₁ is implemented; the output of the first sub-decoding module together with the feature matrix F_{B} are taken as the input of the second sub-decoding module, and the second vector group Q₂, the second convolution matrix M₂ and the feature matrix F_{B} are processed by the second sub-decoding module, to obtain a third vector group Q₃ and a third convolution matrix M₃, and so on.

When i is smaller than L, for any i-th sub-decoding module, the input of the i-th sub-decoding module is the i-th vector group, the i-th convolution matrix and the feature matrix of the sample image, and the output of the i-th sub-decoding module is the (i+1)-th vector group and the (i+1)-th convolution matrix, and the output of the i-th sub-decoding module together with the feature matrix of the sample image are taken as the input of the (i+1)-th sub-decoding module.

By sequential processing of the L sub-decoding modules, the (L+1)-th vector group and the (L+1)-th convolution matrix output by the L-th sub-decoding module are finally obtained, and the (L+1)-th vector group (i.e., QL₊₁ in FIG. 5) and the (L+1)-th convolution matrix (i.e., ML₊₁ in FIG. 5) are output of the decoder module. In the embodiment of the present disclosure, any vector group is a matrix of size N*C, and any convolution matrix is a matrix of size N*H₀*W₀.

Then, the image types are determined according to the (L+1)-th vector group, and N segmented images are determined according to the (L+1)-th convolution matrix. For example, in FIG. 5, the (L+1)-th convolution matrix ML₊₁ is a matrix of N*H₀*W₀, then N H₀*W₀ images can be obtained according to the (L+1)-th convolution matrix ML₊₁, and these N H₀*W₀ images are N segmented images. According to the (L+1)-th convolution matrix ML₊₁, pixel values of each pixel on the N segmented images can be obtained. For any segmented image, an area composed of pixels with pixel values not being 0 is the area detected by the character detection model through the segmented image.

The (L+1)-th vector group QL₊₁ is an N*C matrix, and after the decoder module outputs the (L+1)-th vector group QL₊₁, the (L+1)-th vector group QL₊₁ can be multiplied by a first matrix to obtain an N*3 matrix Q, which includes N vectors, and each vector indicates an image type of a segmented image. The image type indicates that the segmented image includes a text instance, background or other areas, where the inclusion of background or other areas indicates that the corresponding segmented image does not include any text instance.

Any sub-decoding module in the embodiment of the present disclosure can be obtained based on the Transformer feature extraction network. At present, the input of the Transformer feature extraction network is the feature matrix of the image and a set of vectors that are learnable. In the embodiment of the present disclosure, besides the feature matrix of the sample image and the preset vector group that is learnable, the first convolution matrix is also added as the input, so that the final output (L+1)-th preset vector group can focus on a local part of the sample image after being normalized and dot-multiplied by a corresponding matrix, instead of performing an attention operation on the whole sample image, thus speeding up the convergence speed of the whole decoder module and improving the detection accuracy of the model.

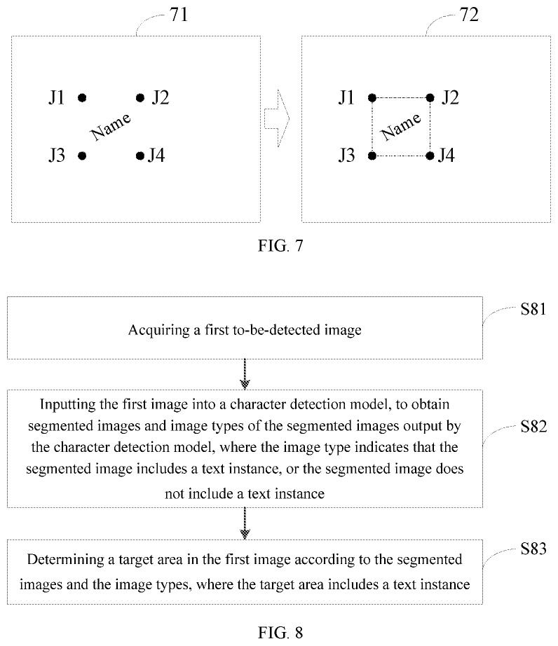

In the above embodiment, step S22 in the embodiment of FIG. 2 is described in detail with reference to FIG. 3-FIG. 5. In the following, step S23 in the embodiment of FIG. 2 will be further detailed with reference to FIG. 6 and FIG. 7.

After obtaining the plurality of segmented images and the image types of segmented images, at least one target area can be determined in the sample image according to the plurality of segmented images and the image types, and the target area is the area including a text instance detected by the character detection model.

For example, it can be understood with reference to FIG. 6. FIG. 6 is a schematic diagram 1 of determining an area corresponding to a segmented image provided by an embodiment of the present disclosure. As shown in FIG. 6, the size of the segmented image 61 is 3*3, that is, each row of the segmented image 61 includes W₀=3 pixels, and each column of the segmented image 61 includes H₀=3 pixels. In FIG. 6, a small box represents one pixel on the image, and FIG. 6 only shows the corresponding relationship of pixels, but does not show the actual display effect.

Since the sizes H₀ and W₀ of the segmented image 61 are related to the size of the sample image 62, that is, H₁=kH₀ and W₁=kW₀, in FIG. 6, k=4 is taken as an example, the size of the sample image 62 is 12*12, that is, each row of the sample image 62 includes 12 pixels, and each column also includes 12 pixels.

In the example in FIG. 6, there are three pixels with pixel values not being 0 on the segmented image 61, which are pixel A, pixel B and pixel C, then an area can be determined on the sample image 62 according to the pixel A, pixel B and pixel C.

Specifically, since H₁=kH₀ and W₁=kW₀, one pixel on the segmented image corresponds to k² pixels on the sample image. For example, in FIG. 6, any pixel on the segmented image 61 corresponds to 16 pixels on the sample image 62. Therefore, for pixel A, 16 pixels corresponding to the pixel A on the sample image 62 can be determined according to the position of the pixel A on the segmented image 61, as shown by area 63 of FIG. 6. Similarly, 16 pixels corresponding to the pixel B on the sample image 62 can be determined according to the position of the pixel B on the segmented image 61; 16 pixels corresponding to the pixel C on the sample image 62 can be determined according to the position of the pixel C on the segmented image 61. In FIG. 6, the shaded portion on the sample image 62 refers to pixels on the sample image 62 corresponding to the pixel A, pixel B and pixel C, and FIG. 6 also shows 16 pixels on the sample image 62 corresponding to the pixel C.

After respective pixels on the sample image 62 corresponding to the pixel A, pixel B and pixel C are determined, the area corresponding to the segmented image 61 on the sample image can be determined according to the respective pixels. This process will be described in the following with reference to FIG. 7.

FIG. 7 is a schematic diagram 2 of determining an area corresponding to a segmented image provided by an embodiment of the present disclosure. As shown in FIG. 7, respective pixels corresponding to the segmented image are determined on the sample image 71. According to the positions of the respective pixels on the sample image 71, four-corner points J1 (x1, y1), J2 (x2, y1), J3 (x1, y2) and J4 (x2, y2) can be determined, where any pixel (x, y) corresponding to the segmented image satisfies x1=<x=<x2, y1=<y=<y2. Then, according to the four-corner points J1, J2, J3 and J4, an area corresponding to the segmented image can be obtained, and this area is shown by dotted lines in the image 72.

For any segmented image, the area corresponding to the segmented image can be determined according to the method illustrated in FIG. 7. Therefore, after the plurality of segmented images are obtained, areas corresponding to the plurality of segmented images in the sample image can be determined according to the plurality of segmented images. Then, at least one target area is determined in the areas corresponding to the plurality of segmented images according to the image types corresponding to the respective segmented images. Specifically, for any area, if the image type indicates that the segmented image corresponding to the area includes a text instance, then the area can be determined as a target area; if the image type indicates that the segmented image corresponding to the area does not include any text instance, and then the area can be determined as a non-target area.

The target area finally determined is the text area detected by the character detection model, and then a parameter of the character detection model is adjusted according to the target area and the marked area on the marked image. Specifically, in the training stage, bipartite matching algorithm can be used to match the predicted text area with the marked image, and the classification loss and segmentation loss can be calculated. For example, the segmentation loss can include the cross entropy loss of two-classification, etc.

For any group of training samples, the character detection model can be trained through the method illustrated by the above embodiments. When the termination condition of model training is reached, the training process can be terminated, and the trained character detection model is obtained. The termination condition of model training may be that, for example, the training times reaches a preset times, and for another example, a difference value between the target area and the marked area on the marked image is smaller than or equal to a preset value, etc.

As described above, embodiments of the present disclosure provide a model training method, which is used to train a character detection model. In the model training process, the preset vector group is first acquired, and the feature matrix of the sample image is extracted through the encoder module, and convolution processing is performed on the feature matrix and the preset vector group to obtain the convolution matrix, and the preset vector group, the feature matrix and the convolution matrix are processed through the decoder module, since the decoder module includes a plurality of sub-decoding modules, the preset vector group and the convolution matrix are dynamically updated through the plurality of sub-decoding modules, to finally obtain the plurality of segmented images and the image types of the segmented images. The a parameter of the character detection model is adjusted based on the segmented images, the image types and the marked image, so that the character detection model has the ability to detect the text instance in the image after the training is completed, and characters in the image can be detected in the unit of text instance to obtain a detection result, and the accuracy of the character detection is high.

In the above embodiments, the training process of the character detection model is described. After the training of the character detection model is completed, the character detection model can be used for character detection, and the process of character detection performed by the character detection model will be described in the following.

FIG. 8 is a schematic flowchart of a character detection method provided by an embodiment of the present disclosure. As shown in FIG. 8, the method may include:

S81, acquiring a first to-be-detected image.

The first image is the to-be-detected image, and the first image includes characters. For example, the first image may be an image obtained by scanning a test paper, the first image may be an image obtained by photographing an ID card, and the first image may be an image obtained by photographing a website, and so on.

S82, inputting the first image into a character detection model, to obtain segmented images and image types of the segmented images output by the character detection model, where the image type indicates that the segmented image includes a text instance, or the segmented image does not include a text instance.

The character detection model in the embodiment of the present disclosure is a trained character detection model, and reference can be made to description of the embodiments of FIG. 2-FIG. 7 for the training process of the character detection model, which will not be repeated here. After the training of the character detection model is completed, the character detection model has the ability of detecting characters in the image. Therefore, after the first image is input into the character detection model, the first image is processed through the character detection model, and a plurality of segmented images and image types of the segmented images can be obtained. The image type indicate that the corresponding the segmented image includes a text instance, or, does not include a text instance.

The text instance represents an independent text entry type, and one text instance may include one or more characters. The text instance will be described with reference to an example. A certain image includes related information of a certain vehicle, the image includes license plate information of this vehicle-“PlateNo. A12345”. Then for this image, “PlateNo.” is a text instance on the image, and “A12345” is another text instance on the image, and “PlateNo.” and “A12345” are different text instances.

S83, determining a target area in the first image according to the segmented images and the image types, where the target area includes a text instance.

In the embodiment of the present disclosure, the first image is detected by the character detection model in the unit of text instance, where each segmented image corresponds to one area on the first image, and the image type of the segmented image indicates whether the corresponding area includes a text instance. When the image type indicates that the area includes a text instance, the area can be determined as a target area. For any segmented image and the corresponding image type, this method can be used to determine whether the area corresponding to the segmented image is the target area. Finally, according to the plurality of segmented images and the image types, at least one target area is determined on the first image, and the target area includes a text instance, so that character detection on the first image in the unit of text instance is implemented.

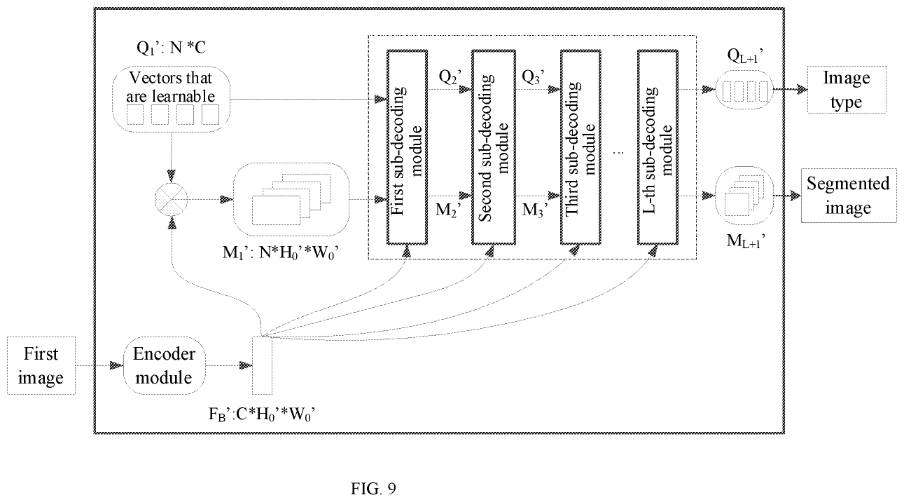

In order to enable readers to have a deeper understanding of the implementation principle of the present disclosure, the embodiment shown in FIG. 8 will be further refined with reference to the following FIG. 9.

First, the processing process of the first image by the character detection model in S82 of the embodiment of FIG. 8 will be described with reference to FIG. 9. FIG. 9 is a schematic diagram of a character detection process provided by an embodiment of the present disclosure. As shown in FIG. 9, the character detection model includes a preset vector group, an encoder module and a decoder module. The first image is a to-be-detected image, and the size of the first image is H1′*W1′, that is, the first image includes H1′ pixels in the vertical direction, and includes W1′ pixels in the transverse direction. After the first image is input into the character detection model, feature extraction processing is first performed on the first image through the encoder module, to obtain a feature matrix of the first image, that is, matrix F_{B}′ in FIG. 9.

By processing the first image with the encoder module, the feature matrix F_{B}′ can be obtained. The feature matrix F_{B} is a feature matrix of C*H₀′*W₀′, and C, H₀′ and W₀′ are positive integers greater than or equal to 1. C represents the number of channels, and the value of C is related to the structure of the encoder module. The sizes of H₀′ and W₀′ are related to the size of the first image, and H₁′=kH₀′, W₁′=kW₀′, k is a positive integer. The value of k is decided by the encoder module, and in some embodiments, k is greater than or equal to 1, for example, k may be 2, 4, 8, etc. By processing the first image with the encoder module, the high-resolution features of the first image can be extracted, thus improving the detection accuracy on the first image by the model.

After the feature matrix of the first image is obtained, a preset vector group can be acquired, and the preset vector group includes N preset vectors, where N is a positive integer. It needs to be note that, N is a parameter pre-defined in the character detection model, and N decides a maximum number of text instances that the character detection model can detect, and hence, N needs to be greater than or equal to the number of text instances included in the first image. For example, the number of text instances included in a certain first image is 100, then N needs to take a value greater than or equal to 100.

In the example of FIG. 9, the preset vector group is an N*C matrix, and the preset vector group Q₁′ includes N preset vectors, and each preset vector includes C elements, where C is the number of channels. The preset vectors in the preset vector group Q₁′ are a group of vectors that are learnable. Initially, values of each element in the preset vector can be initialized, that is, original values of each preset vector can be set arbitrarily, and in the subsequent processing process on the first image by the model, the preset vectors will keep learning, so as to update values of the elements of the preset vectors themselves.

After the preset vector group and the feature matrix of the first image are acquired, N segmented images and image types of the N segmented images can be obtained according to the preset vector group and the feature matrix. As shown in FIG. 9, first, convolution processing is performed on the preset vector group Q₁′ and the feature matrix F_{B}′ of the sample image, to obtain a first convolution matrix M₁′, where M₁′ is a matrix of N*H₀′*W₀′. Then, the preset vector group, the first convolution matrix and the feature matrix of the first image are input into the decoder module, and the preset vector group, the first convolution matrix and the feature matrix of the first image are processed through the decoder module, to obtain N segmented images and image types.

The decoder module includes L sub-decoding modules, which are called the first sub-decoding module, the second sub-decoding module, . . . , and the L-th sub-decoding module from left to right in FIG. 9. After the first convolution matrix, the preset vector group and the feature matrix of the first image are input into the decoder module, a first operation is performed, including: processing an i-th vector group, an i-th convolution matrix and the feature matrix of the first image according to an i-th sub-decoding module, to obtain an (i+1)-th vector group and an (i+1)-th convolution matrix, and updating i to i+1. The first vector group is the preset vector group, and i is initially 1, and i is a positive integer.

When i is smaller than L, the first operation is repeatedly performed, until an (L+1)-th vector group and an (L+1)-th convolution matrix are obtained when i is equal to L.

For example, in FIG. 9, after the first convolution matrix M₁′, the preset vector group Q₁′ and the feature matrix F_{B}′ of the first image are input into the decoder module, firstly, the preset vector group Q₁′, the first convolution matrix M₁′ and the feature matrix F_{B}′ are processed by the first sub-decoding module, to obtain a second vector group Q₂′ and a second convolution matrix M₂′, and updating of the preset vector Q₁′ and the first convolution matrix M₁′ is implemented; the output of the first sub-decoding module together with the feature matrix F_{B}′ are taken as the input of the second sub-decoding module, and the second vector group Q₂′, the second convolution matrix M₂′ and the feature matrix F_{B}′ are processed by the second sub-decoding module, to obtain a third vector group Q₃′ and a third convolution matrix M₃′, and so on.

When i is smaller than L, for any i-th sub-decoding module, the input of the i-th sub-decoding module is the i-th vector group, the i-th convolution matrix and the feature matrix of the first image, and the output of the i-th sub-decoding module is the (i+1)-th vector group and the (i+1)-th convolution matrix, and the output of the i-th sub-decoding module together with the feature matrix of the first image are taken as the input of the (i+1)-th sub-decoding module.

By sequential processing of the L sub-decoding modules, the (L+1)-th vector group and the (L+1)-th convolution matrix output by the L-th sub-decoding module are finally obtained, and the (L+1)-th vector group (i.e., QL₊₁′ in FIG. 9) and the (L+1)-th convolution matrix (i.e., ML₊₁′ in FIG. 9) are output of the decoder module. In the embodiment of the present disclosure, any vector group is a matrix of size N*C, and any convolution matrix is a matrix of size N*H₀′*W₀′.

Then, the image types are determined according to the (L+1)-th vector group, and N segmented images are determined according to the (L+1)-th convolution matrix. For example, in FIG. 9, the (L+1)-th convolution matrix ML₊₁′ is a matrix of N*H₀′*W₀′, then N H₀′*W₀′ images can be obtained according to the (L+1)-th convolution matrix ML₊₁′, and these N H₀′ *W₀′ images are N segmented images. According to the (L+1)-th convolution matrix ML₊₁′, pixel values of each pixel on the N segmented images can be obtained. For any segmented image, an area composed of pixels with pixel values not being 0 is the area detected by the character detection model through the segmented image.

The (L+1)-th vector group is an N*C matrix, and after the decoder module outputs the (L+1)-th vector group, the (L+1)-th vector group can be multiplied by a first matrix to obtain an N*3 matrix Q′, which includes N vectors, and each vector indicates an image type of a segmented image. The image type indicates that the segmented image includes a text instance, background or other areas, where the inclusion of background or other areas indicates that the corresponding segmented image does not include any text instance. In the embodiment of the present disclosure, besides the feature matrix of the first image and the preset vector group that is learnable, the first convolution matrix is also added as the input, so that the final output (L+1)-th preset vector group can focus on a local part of the first image after being normalized and dot-multiplied by a corresponding matrix, instead of performing an attention operation on the whole first image, thus speeding up the convergence speed of the whole decoder module and improving the detection accuracy of the model.

The related contents of S83 in the embodiment of FIG. 8 will be described below.

After obtaining the plurality of segmented images and the image types of segmented images, the target area can be determined in the first image according to the plurality of segmented images and the image types, and the target area is the area including a text instance detected by the character detection model.

Specifically, since H₁′=kH₀′ and W₁′=kW₀′, one pixel on the segmented image corresponds to k² pixels on the first image. For any segmented image, according to the position of the non-0 pixel on the segmented image, the k² pixels corresponding to the pixel can be determined on the first image. Then, according to the plurality of pixels on the first image corresponding to the non-0 pixel on the segmented image, an area on the first image corresponding to the segmented image can be determined. For any segmented image, the area corresponding to the segmented image can be determined according to the above method. Therefore, after the plurality of segmented images are obtained, areas corresponding to the plurality of segmented images in the first image can be determined according to the plurality of segmented images. Then, at least one target area is determined in the areas corresponding to the plurality of segmented images according to the image types corresponding to the respective segmented images. For example, if the image type indicates that the segmented image corresponding to the area includes a text instance, then the area corresponding to the segmented image can be determined as a target area; if the image type indicates that the segmented image corresponding to the area does not include any text instance, then the area corresponding to the segmented image can be determined as a non-target area.

As described above, according to the character detection method provided by the embodiment of the present disclosure, the first to-be-detected image is first acquired, and the first image is input into the character detection model, the first image is processed through the character detection model, and segmented images and image types of the segmented images are obtained. The first image is detected by the character detection model in the unit of text instance, where each segmented image corresponds to one area on the first image, and the image type of the segmented image indicates whether the corresponding area includes a text instance. When the image type indicates that the area includes a text instance, the area can be determined as a target area. For any segmented image and the corresponding image type, this method can be used to determine whether the area corresponding to the segmented image is the target area. Finally, according to the plurality of segmented images and the image types, at least one target area is determined on the first image, and the target area includes the text instance, so that character detection on the first image in the unit of text instance is implemented, and the accuracy of the character detection is high.

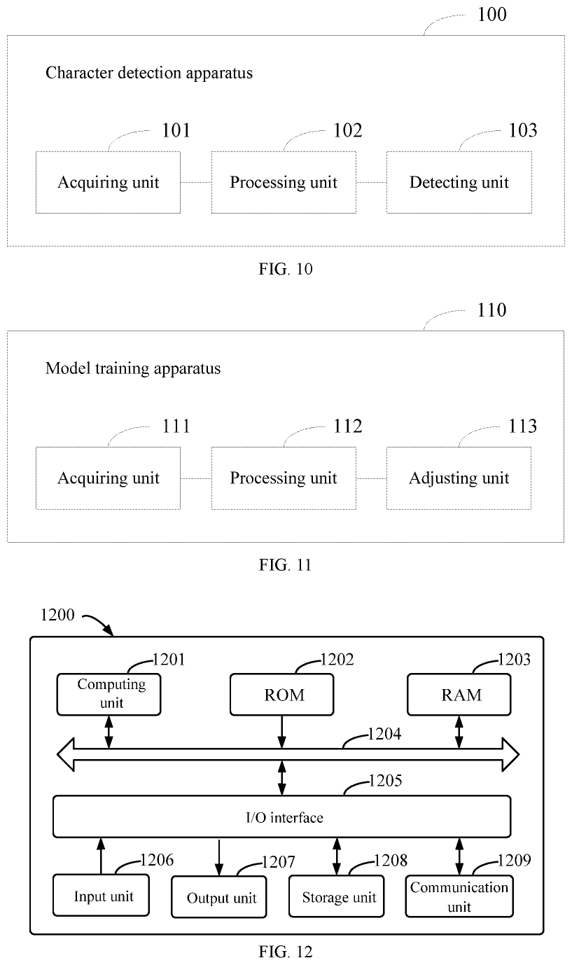

FIG. 10 is a schematic structural diagram of a character detection apparatus provided by an embodiment of the present disclosure. As shown in FIG. 10, the character detection apparatus 100 includes:

an acquiring module 101, configured to acquire a first to-be-detected image;

a processing unit 102, configured to input the first image into a character detection model, to obtain segmented images and image types of the segmented images output by the character detection model, where the image type indicates that the segmented image includes a text instance, or the segmented image does not include a text instance; and

a detecting unit 103, configured to determine a target area in the first image according to the segmented images and the image types, where the target area includes a text instance.

In a possible implementation, the processing unit includes:

an acquiring module, configured to acquire a preset vector group, where the preset vector group includes N preset vectors, and N is greater than or equal to a number of text instances included in the first image, and N is a positive integer;

a first processing module, configured to perform feature extraction processing on the first image, to obtain a feature matrix of the first image; and

a second processing module, configured to acquire N segmented images and image types of the N segmented images according to the preset vector group and the feature matrix.

In a possible implementation, the second processing module includes:

a first processing sub-module, configured to perform convolution processing on the preset vector group and the feature matrix, to obtain an initial i-th convolution matrix, where i=1; and

a second processing sub-module, configured to process the preset vector group, the i-th convolution matrix and the feature matrix according to a decoder module, to obtain the N segmented images and the image types of the N segmented images.

In a possible implementation, the decoder module includes L sub-decoding modules, where L is an integer greater than or equal to 1; the second processing sub-module is specifically configured to:

perform a first operation, where the first operation includes: processing an i-th vector group, the i-th convolution matrix and the feature matrix according to an i-th sub-decoding module, to obtain an (i+1)-th vector group and an (i+1)-th convolution matrix, and updating i to i+1; where a first vector group is the preset vector group, and i is initially 1, and i is a positive integer;

when i is smaller than L, repeatedly perform the first operation, until obtaining an (L+1)-th vector group and an (L+1)-th convolution matrix when i is equal to L;

determine and obtain the image types according to the (L+1)-th vector group; and

determine and obtain the N segmented images according to the (L+1)-th convolution matrix.

In a possible implementation, the detecting unit includes:

a first detecting module, configured to determine areas corresponding to the segmented images in the first image according to the segmented images; and

a second detecting module, configured to determine the target area in the areas corresponding to the segmented images according to the image types.

The character detection apparatus provided by an embodiment of the present disclosure is configured to perform the above method embodiments, and the principle and technical effect are similar, which will not be repeated in the present embodiment.

FIG. 11 is a schematic structural diagram of a model training apparatus provided by an embodiment of the present disclosure. As shown in FIG. 11, the model training apparatus 110 includes:

an acquiring unit 111, configured to acquire a training sample, where the training sample includes a sample image and a marked image, where the marked image is an image obtained by marking a text instance in the sample image;

a processing unit 112, configured to input the sample image into a character detection model, to obtain segmented images and image types of the segmented images output by the character detection model, where the image type indicates that the segmented image includes the text instance, or the segmented image does not include the text instance; and

an adjusting unit 113, configured to adjust a parameter of the character detection model according to the segmented images, the image types of the segmented images and the marked image.

In a possible implementation, the processing unit 112 includes:

an acquiring module, configured to acquire a preset vector group, where the preset vector group includes N preset vectors, and N is greater than or equal to a number of text instances included in the sample image, and N is a positive integer;

a first processing module, configured to perform feature extraction processing on the sample image, to obtain a feature matrix of the sample image; and

a second processing module, configured to acquire N segmented images and image types of the N segmented images according to the preset vector group and the feature matrix.

In a possible implementation, the second processing module includes:

a first processing sub-module, configured to perform convolution processing on the preset vector group and the feature matrix, to obtain an initial i-th convolution matrix, where i=1; and

a second processing sub-module, configured to process the preset vector group, the i-th convolution matrix and the feature matrix according to a decoder module, to obtain the N segmented images and the image types of the N segmented images.

In a possible implementation, the decoder module includes L sub-decoding modules, where L is an integer greater than or equal to 1; the second processing sub-module is specifically configured to:

perform a first operation, where the first operation includes: processing an i-th vector group, the i-th convolution matrix and the feature matrix according to an i-th sub-decoding module, to obtain an (i+1)-th vector group and an (i+1)-th convolution matrix, and updating i to i+1; where a first vector group is the preset vector group, and i is initially 1, and i is a positive integer;

when i is smaller than L, repeatedly perform the first operation, until obtaining an (L+1)-th vector group and an (L+1)-th convolution matrix when i is equal to L;

determine and obtain the image types according to the (L+1)-th vector group; and

determine and obtain the N segmented images according to the (L+1)-th convolution matrix.

In a possible implementation, the adjusting unit 113 includes:

a determining module, configured to determine target areas in the sample image according to the segmented images and the image types;

an adjusting module, configured to adjust the parameter of the character detection model according to the target areas and the marked image.

In a possible implementation, the determining module includes:

a first determining sub-module, configured to determine areas corresponding to the segmented images in the sample image according to the segmented images; and

a second determining sub-module, configured to determine the target area in the areas corresponding to the segmented images according to the image types.

The model training apparatus provided by an embodiment of the present disclosure is configured to perform the above method embodiments, and the principle and technical effect are similar, which will not be repeated in the present embodiment.

The present disclosure provides a character detection method and apparatus and a model training method and apparatus, a device and a storage medium, applied to the technical field of deep learning, image processing and computer vision in the technical field of artificial intelligence, so as to achieve the purpose of improving accuracy of character detection.

It shall be noted that, the character detection model is not a character detection model aimed for a certain user, and does not reflect personal information of a certain user. It shall be noted that, the sample image in the present embodiment is from a public data set.

In the technical solution of the present disclosure, the collection, storage, use, processing, transmission, provision and disclosure of personal information of users are all in line with the provisions of relevant laws and regulations, and do not violate public order and good customs.

According to the embodiment of the present disclosure, the present disclosure further provides an electronic device, a readable storage medium and a computer program product.

According to the embodiment of the present disclosure, the present disclosure further provides a computer program product, where the computer program product includes: a computer program, stored in a readable storage medium, at least one processor of an electronic device can read the computer program from the readable storage medium, and the at least one processor executes the computer program to cause the electronic device to perform the method according to any one of the above embodiments.

FIG. 12 shows a schematic block diagram of an example electronic device 1200 that can be used to implement the embodiments of the present disclosure. Electronic devices are intended to represent various forms of digital computers, such as laptop computers, desktop computers, workstations, personal digital assistants, servers, blade servers, mainframe computers, and other suitable computers. Electronic devices can also represent various forms of mobile devices, such as personal digital processing, cellular phones, smart phones, wearable devices and other similar computing devices. The components shown herein, their connections and relationships, and their functions are only examples, and are not intended to limit the implementation of the present disclosure described and/or claimed herein.

As shown in FIG. 12, the device 1200 includes a computing unit 1201, which can perform various appropriate actions and processes according to a computer program stored in a read only memory (ROM) 1202 or a computer program loaded from a storage unit 1208 into a random access memory (RAM) 1203. In the RAM 1203, various programs and data required for the operation of the device 1200 can also be stored. The computing unit 1201, ROM 1202, and RAM 1203 are connected to each other through a bus 1204. An input/output (I/O) interface 1205 is also connected to the bus 1204.

A number of components in the device 1200 are connected to the I/O interface 1205, including an input unit 1206, such as a keyboard, a mouse, etc.; an output unit 1207, such as various types of displays, speakers, etc.; a storage unit 1208, such as magnetic disk, optical disk, etc.; and a communication unit 1209, such as a network card, a modem, a wireless communication transceiver, etc. The communication unit 1209 allows the device 1200 to exchange information/data with other devices through a computer network such as the Internet and/or various telecommunication networks.

The computing unit 1201 can be various general-purpose and/or special-purpose processing components with processing and computing capabilities. Some examples of the computing unit 1201 include, but are not limited to, a central processing unit (CPU), a graphics processing unit (GPU), various dedicated artificial intelligence (AI) computing chips, various computing units running machine learning model algorithms, a digital signal processor (DSP), and any suitable processor, controller, micro-controller, etc. The computing unit 1201 executes the various methods and processes described above, such as the model training method or the character detection method. For example, in some embodiments, the model training method or the character detection method can be implemented as a computer software program tangibly embodied in a machine-readable medium, such as the storage unit 1208. In some embodiments, part or all of the computer program can be loaded and/or installed on the device 1200 via the ROM 1202 and/or the communication unit 1209. When the computer program is loaded into the RAM 1203 and executed by the computing unit 1201, one or more steps of the model training method or the character detection method described above may be executed. Alternatively, in other embodiments, the computing unit 1201 may be configured to execute the model training method or the character detection method by any other suitable means (for example, by means of firmware).

The various embodiments of the systems and technologies described above can be implemented in digital electronic circuit systems, integrated circuit systems, field programmable gate arrays (FPGA), application specific integrated circuits (ASIC), application specific standard products (ASSP), system-on-chips (SOC), complex programmable logic devices (CPLD), computer hardware, firmware, software, and/or their combinations. These various embodiments may include being implemented in one or more computer programs that can be executed and/or interpreted on a programmable system including at least one programmable processor, which can be a special-purpose or general-purpose programmable processor that can receive data and instructions from and transmit data and instructions to a storage system, at least one input device, and at least one output device.

The program code for implementing the method of the present disclosure can be written in any combination of one or more programming languages. These program codes may be provided to the processors or controllers of general-purpose computers, special-purpose computers or other programmable data processing devices, so that when executed by the processors or controllers, the program codes cause the functions/operations specified in the flowcharts and/or block diagrams to be implemented. The program can be completely executed on the machine, partially executed on the machine, partially executed on the machine as an independent software package, partially executed on a remote machine or completely executed on a remote machine or server.

In the context of the present disclosure, a machine-readable medium can be a tangible medium that can contain or store a program for use by or in connection with an instruction execution system, apparatus or device. The machine-readable medium may be a machine-readable signal medium or a machine-readable storage medium. The machine-readable medium can include, but are not limited to, electronic, magnetic, optical, electromagnetic, infrared, or semiconductor systems, apparatuses or devices, or any suitable combination of the above. More specific examples of machine-readable storage medium will include an electrical connection based on one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any suitable combination of the above.

To provide interaction with users, the systems and technologies described herein can be implemented on a computer, which has a display device (for example, CRT (cathode ray tube) or LCD (liquid crystal display) monitor) for displaying information to users; and a keyboard and a pointing apparatus (for example, a mouse or a trackball) through which a user can provide input to a computer. Other kinds of apparatuses can also be used to provide interaction with users; for example, the feedback provided to the user can be any form of sensory feedback (e.g., visual feedback, auditory feedback, or tactile feedback); and the input from the user can be received in any form (including acoustic input, voice input or tactile input).

The systems and technologies described herein can be implemented in a computing system including a back-end component (e.g., as a data server), a computing system including a middleware component (e.g., an application server), or a computing system including a front-end component (e.g., a user computer with a graphical user interface or a web browser through which users can interact with the embodiments of the systems and technologies described herein), or include such back-end components, middleware components, or front-end components. The components of the system can be connected to each other by digital data communication in any form or medium (e.g., communication network). Examples of the communication network include: local area network (LAN), wide area network (WAN) and the Internet.

The computer system may include a client and a server. The client and the server are usually far away from each other and usually interact through the communication network. The relationship between the client and the server is generated by computer programs running on corresponding computers and having a client-server relationship with each other. The server may be a cloud server, also known as cloud computing server or cloud host, which is a host product in the cloud computing service system, so as to solve the shortcomings of traditional physical host and VPS service (“Virtual Private Server”, or “VPS” for short), such as difficult management and weak business scalability. The server can also be a distributed system server or a server combined with block chain.

It should be understood that steps can be reordered, added, or deleted using the various forms of processes shown above. For example, the steps described in the present disclosure can be executed in parallel, sequentially or in different orders, so long as the desired results of the technical solutions disclosed in the present disclosure can be achieved, which is not restricted here.

The above specific embodiments do not limit the scope of protection of the present disclosure. Those skilled in the art should understand that various modifications, combinations, sub-combinations and substitutions can be made according to design requirements and other factors. Any modification, equivalent substitution and improvement made within the spirit and principle of the present disclosure shall be included in the scope of protection of the present disclosure.

What is claimed is:

1. A character detection method, comprising:
acquiring a first to-be-detected image;
inputting the first image into a character detection model, to obtain segmented images and image types of the segmented images output by the character detection model, wherein the image type indicates that the segmented image comprises a text instance, or the segmented image does not comprise a text instance; and
determining a target area in the first image according to the segmented images and the image types, wherein the target area comprises a text instance.

2. The method according to claim 1, wherein the inputting the first image into the character detection model, to obtain the segmented images and the image types of the segmented images output by the character detection model comprises:
acquiring a preset vector group, wherein the preset vector group comprises N preset vectors, and N is greater than or equal to a number of text instances comprised in the first image, and N is a positive integer;
performing feature extraction processing on the first image, to obtain a feature matrix of the first image; and
acquiring N segmented images and image types of the N segmented images according to the preset vector group and the feature matrix.

3. The method according to claim 2, wherein the acquiring the N segmented images and the image types of the N segmented images according to the preset vector group and the feature matrix comprises:
performing convolution processing on the preset vector group and the feature matrix, to obtain an initial i-th convolution matrix, wherein i=1; and
processing the preset vector group, the i-th convolution matrix and the feature matrix according to a decoder module, to obtain the N segmented images and the image types of the N segmented images.

4. The method according to claim 3, wherein the decoder module comprises L sub-decoding modules, wherein L is an integer greater than or equal to 1; the processing the preset vector group, the i-th convolution matrix and the feature matrix according to the decoder module, to obtain the N segmented images and the image types of the N segmented images comprises:
performing a first operation, wherein the first operation comprises: processing an i-th vector group, the i-th convolution matrix and the feature matrix according to an i-th sub-decoding module, to obtain an (i+1)-th vector group and an (i+1)-th convolution matrix, and updating i to i+1; wherein a first vector group is the preset vector group, and i is initially 1, and i is a positive integer;
when i is smaller than L, repeatedly performing the first operation, until obtaining an (L+1)-th vector group and an (L+1)-th convolution matrix when i is equal to L;
determining and obtaining the image types according to the (L+1)-th vector group; and
determining and obtaining the N segmented images according to the (L+1)-th convolution matrix.

5. The method according to claim 1, wherein the determining the target area in the first image according to the segmented images and the image types comprises:
determining areas corresponding to the segmented images in the first image according to the segmented images; and
determining the target area in the areas corresponding to the segmented images according to the image types.

6. The method according to claim 2, wherein the determining the target area in the first image according to the segmented images and the image types comprises:
determining areas corresponding to the segmented images in the first image according to the segmented images; and
determining the target area in the areas corresponding to the segmented images according to the image types.

7. The method according to claim 3, wherein the determining the target area in the first image according to the segmented images and the image types comprises:
determining areas corresponding to the segmented images in the first image according to the segmented images; and
determining the target area in the areas corresponding to the segmented images according to the image types.

8. The method according to claim 4, wherein the determining the target area in the first image according to the segmented images and the image types comprises:
determining areas corresponding to the segmented images in the first image according to the segmented images; and
determining the target area in the areas corresponding to the segmented images according to the image types.

9. A model training method, comprising:
acquiring a training sample, wherein the training sample comprises a sample image and a marked image, wherein the marked image is an image obtained by marking a text instance in the sample image;
inputting the sample image into a character detection model, to obtain segmented images and image types of the segmented images output by the character detection model, wherein the image type indicates that the segmented image comprises the text instance, or the segmented image does not comprise the text instance; and
adjusting a parameter of the character detection model according to the segmented images, the image types of the segmented images and the marked image.

10. The method according to claim 9, wherein the inputting the sample image into the character detection model, to obtain the segmented images and the image types of the segmented images output by the character detection model comprises:
acquiring a preset vector group, wherein the preset vector group comprises N preset vectors, and N is greater than or equal to a number of text instances comprised in the sample image, and N is a positive integer;
performing feature extraction processing on the sample image, to obtain a feature matrix of the sample image; and
acquiring N segmented images and image types of the N segmented images according to the preset vector group and the feature matrix.

11. The method according to claim 10, wherein the acquiring the N segmented images and the image types of the N segmented images according to the preset vector group and the feature matrix comprises:
performing convolution processing on the preset vector group and the feature matrix, to obtain an initial i-th convolution matrix, wherein i=1; and
processing the preset vector group, the i-th convolution matrix and the feature matrix according to a decoder module, to obtain the N segmented images and the image types of the N segmented images.

12. The method according to claim 11, wherein the decoder module comprises L sub-decoding modules, wherein L is an integer greater than or equal to 1; the processing the preset vector group, the i-th convolution matrix and the feature matrix according to the decoder module, to obtain the N segmented images and the image types of the N segmented images comprises:
performing a first operation, wherein the first operation comprises: processing an i-th vector group, the i-th convolution matrix and the feature matrix according to an i-th sub-decoding module, to obtain an (i+1)-th vector group and an (i+1)-th convolution matrix, and updating i to i+1; wherein a first vector group is the preset vector group, and i is initially 1, and i is a positive integer;
when i is smaller than L, repeatedly performing the first operation, until obtaining an (L+1)-th vector group and an (L+1)-th convolution matrix when i is equal to L;
determining and obtaining the image types according to the (L+1)-th vector group; and
determining and obtaining the N segmented images according to the (L+1)-th convolution matrix.

13. The method according to claim 9, wherein the adjusting a parameter of the character detection model according to the segmented images, the image types of the segmented images and the marked image comprises:
determining target areas in the sample image according to the segmented images and the image types; and
adjusting the parameter of the character detection model according to the target areas and the marked image.

14. The method according to claim 10, wherein the adjusting a parameter of the character detection model according to the segmented images, the image types of the segmented images and the marked image comprises:
determining target areas in the sample image according to the segmented images and the image types; and
adjusting the parameter of the character detection model according to the target areas and the marked image.

15. The method according to claim 13, wherein the determining the target areas in the sample image according to the segmented images and the image types comprises:
determining areas corresponding to the segmented images in the sample image according to the segmented images; and
determining the target area in the areas corresponding to the segmented images according to the image types.

16. The method according to claim 14, wherein the determining the target areas in the sample image according to the segmented images and the image types comprises:
determining areas corresponding to the segmented images in the sample image according to the segmented images; and
determining the target area in the areas corresponding to the segmented images according to the image types.

17. A character detection apparatus, comprising:
at least one processor; and
a memory communicatively connected to the at least one processor; wherein
the memory stores an instruction executable by the at least one processor, and the instruction is executed by the at least one processor to cause the at least one processor to:
acquire a first to-be-detected image;
input the first image into a character detection model, to obtain segmented images and image types of the segmented images output by the character detection model, wherein the image type indicates that the segmented image comprises a text instance, or the segmented image does not comprise a text instance; and
determine a target area in the first image according to the segmented images and the image types, wherein the target area comprises a text instance.

18. A model training apparatus, comprising:
at least one processor; and
a memory communicatively connected to the at least one processor; wherein
the memory stores an instruction executable by the at least one processor, and the instruction is executed by the at least one processor to cause the at least one processor to perform the method according to claim 9.

19. A non-transitory computer-readable storage medium storing a computer instruction, wherein the computer instruction is used to cause a computer to execute the method according to claim 1.

20. A non-transitory computer-readable storage medium storing a computer instruction, wherein the computer instruction is used to cause a computer to execute the method according to claim 9.
